(19) United States
(12) Patent Application Publication
(10) Pub. No.: US 2017/0274879 A1
(43) Pub. Date: Sep. 28, 2017

(54) HYDRAULIC BRAKING SYSTEM AND BRAKING OPERATION DEVICE

(71) Applicant: TOYOTA JIDOSHA KABUSHIKI KAISHA, Toyota-shi (JP)

(72) Inventor: Norihiko OKOCHI, Aichi-gun (JP)

(73) Assignee: TOYOTA JIDOSHA KABUSHIKI KAISHA, Toyota-shi (JP)

(21) Appl. No.: 15/429,910

(22) Filed: Feb. 10, 2017

(30) Foreign Application Priority Data
Mar. 22, 2016 (JP) 2016-057089

(51) Int. Cl. B60T 8/40; B60T 13/68; B60T 13/14

(52) U.S. Cl. CPC B60T 8/409; B60T 13/142; B60T 13/686; B60T 2220/04

(57) ABSTRACT

A hydraulic braking system includes: a stroke simulator; a pump configured to suck and discharge working fluid; a hydraulic brake including a brake cylinder connected to the pump; a suction mechanism including a reservoir, a suction portion of the pump, and a suction passage connecting between the reservoir and the suction portion of the pump; a first simulator passage connecting between the stroke simulator and the suction mechanism at a first connecting portion of the suction mechanism; a second simulator passage connecting between the stroke simulator and the suction mechanism in parallel with the first simulator passage at a second connecting portion of the suction mechanism, the second connecting portion being farther from the suction portion of the pump than the first connecting portion; and a flow restricting device provided on the second simulator passage.

### CROSS REFERENCE TO RELATED APPLICATION

The present application claims priority from Japanese Patent Application No. 2016-057089, which was filed on Mar. 22, 2016, the disclosure of which is herein incorporated by reference in its entirety.

### BACKGROUND

The following disclosure relates to a hydraulic braking system including a pump, and a braking operation device.

Patent Document 1 (Japanese Patent Application Publication No. 2015-182631) discloses a hydraulic braking system including: brake cylinders; a pump connected to the brake cylinders; a master cylinder configured to generate a hydraulic pressure in response to depression of a brake pedal; a stroke simulator connected to the master cylinder; and a fluid suction passage connecting between a rearward pressure chamber of the stroke simulator and a suction portion of the pump.

### SUMMARY

An aspect of the disclosure relates to improvement of (i) a braking operation device to which a stroke simulator and a suction mechanism including a suction portion of a pump are connected and (ii) a hydraulic braking system including the braking operation device. For example, an aspect of the disclosure relates to reduction in difference between an operation feeling at low temperatures and the operation feeling at ordinary temperatures.

In one aspect of the disclosure, a hydraulic braking system including a braking operation device is configured such that a stroke simulator and a suction mechanism including a suction portion of a pump are connected to each other in parallel by a first simulator passage and a second simulator passage, and a flow restricting device is provided on the second simulator passage. The second simulator passage is connected to the suction mechanism at a position located farther from the pump than a connecting portion of the first simulator passage. The viscosity of working fluid is higher at low temperatures than at ordinary temperatures, resulting in larger passage resistances, which lead to a less smooth flow of the working fluid. Accordingly, a ratio (s/Fp) of a stroke s to an operating force Fp of the brake operating member is in most cases smaller at low temperatures than at ordinary temperatures. In the hydraulic braking system disclosed in Patent Document 1, the rearward pressure chamber of the stroke simulator is connected to the pump via the fluid suction passage. Thus, the working fluid in a fluid suction passage is sucked by the pump, and the passage resistance of the fluid suction passage is low even at low temperatures. This construction facilitates a flow of the working fluid out of the rearward pressure chamber of the stroke simulator, which allows increase in stroke of the brake operating member, thereby suppressing reduction in the ratio (s/Fp). In the hydraulic braking system disclosed in Patent Document 1, however, the working fluid in the fluid suction passage is sucked by the pump at low temperatures and at ordinary temperatures. Thus, the passage resistance of the fluid suction passage is larger, and the ratio (s/Fp) is relatively smaller at low temperatures than at ordinary temperatures. This results in difference between the operation feeling at low temperatures and the operation feeling at ordinary temperatures, so that the driver may feel discomfort.

In the hydraulic braking system according to the one aspect of the disclosure, in contrast, the flow restricting device is provided on the second simulator passage. Thus, at low temperatures at which the viscosity of the working fluid is high, the working fluid flows less easily via the second simulator passage and more easily via the first simulator passage than at ordinary temperatures. Also, the first simulator passage is connected to the portion of the suction mechanism which is nearer to the pump than the second simulator passage. Thus, the working fluid having flowed from the stroke simulator via the first simulator passage is easily sucked by the pump. Accordingly, increase in stroke of the brake operating member due to suction of the pump is allowed at low temperatures. At ordinary temperatures, in contrast, the viscosity of the working fluid is lower than at low temperatures. Thus, even in the construction in which the flow restricting device is provided, the working fluid flows more easily via the second simulator passage at ordinary temperatures than at low temperatures. The working fluid having flowed from the stroke simulator via the second simulator passage is less easily sucked by the pump than the working fluid having flowed via the first simulator passage. Thus, the increase in stroke of the brake operating member due to the suction of the pump is reduced by a larger amount at ordinary temperatures than at low temperatures. For the reasons described above, it is possible to reduce the difference between the operation feeling at low temperatures and the operation feeling at ordinary temperatures, whereby the requested braking force can be determined to a value desired by the driver both at ordinary temperatures and at low temperatures.

A flow rate of the working fluid that can flow from the stroke simulator is restricted due to resistances of passages connected to the stroke simulator, for example. Thus, in the case where the brake operating member is operated quickly, the flow of the working fluid from the stroke simulator is restricted, and thereby the increase in stroke of the brake operating member is not allowed sufficiently. Thus, as at low temperatures, the ratio (s/Fp) of the stroke s to the operating force Fp of the brake operating member is in most cases small in the case where the quick operation is performed. In the present hydraulic braking system, in contrast, the flow restricting device is provided on the second simulator passage. With this construction, the working fluid flows more easily from the stroke simulator through the first simulator passage in the quick operation than in a normal operation on the brake operating member. Also, the flow rate is less in the normal operation than in the quick operation. Thus, even in the construction in which the flow restricting device is provided, the working fluid flows more easily from the stroke simulator through the second simulator passage in the normal operation than in the quick operation. As a result, the increase in stroke of the brake operating member due to the suction of the pump is reduced by a larger amount in the normal operation than in the quick operation, resulting in reduced difference between the operation feeling in the quick operation and the operation feeling in the normal operation.

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIG. 1 is a circuit diagram of a hydraulic braking system according to a first embodiment, and this hydraulic braking system includes a braking operation device according to a first embodiment;

FIG. 2A is a cross-sectional view of a portion of a unit which includes a pump; and FIG. 2B is a cross-sectional view different from FIG. 2A;

FIG. 3 is a view illustrating a brake ECU and devices connected thereto in the hydraulic braking system;

FIG. 4A is a flow chart illustrating a brake-cylinder hydraulic-pressure control program stored in a storage of a brake ECU of the hydraulic braking system, and FIG. 4B is a flow chart illustrating a portion of the program in FIG. 4A (for obtaining a requested braking force);

FIG. 5 is a view illustrating a coefficient determination table stored in the storage of the brake ECU;

FIG. 6 is a circuit diagram of a hydraulic braking system according to a second embodiment, and this hydraulic braking system includes a braking operation device according to the first embodiment;

FIG. 7 is a view illustrating the brake ECU and devices connected thereto in the hydraulic braking system;

FIG. 8 is a flow chart illustrating an electromagnetic-valve control program stored in the storage;

FIG. 9 is a circuit diagram of a hydraulic braking system according to a third embodiment, and this hydraulic braking system includes the braking operation device according to the first embodiment;

FIG. 10 is a circuit diagram of a hydraulic braking system according to a fourth embodiment, and the present hydraulic braking system includes the braking operation device according to the first embodiment;

FIG. 11 is a view illustrating the brake ECU and devices connected thereto in the hydraulic braking system; and

FIG. 12 is a flow chart illustrating an electromagnetic-valve control program stored in the storage.

### DETAILED DESCRIPTION OF THE EMBODIMENTS

Hereinafter, there will be described embodiments by reference to the drawings. A hydraulic braking system according to one embodiment includes a braking operation device according to one embodiment.

### First Embodiment

### Configuration of Hydraulic Braking System

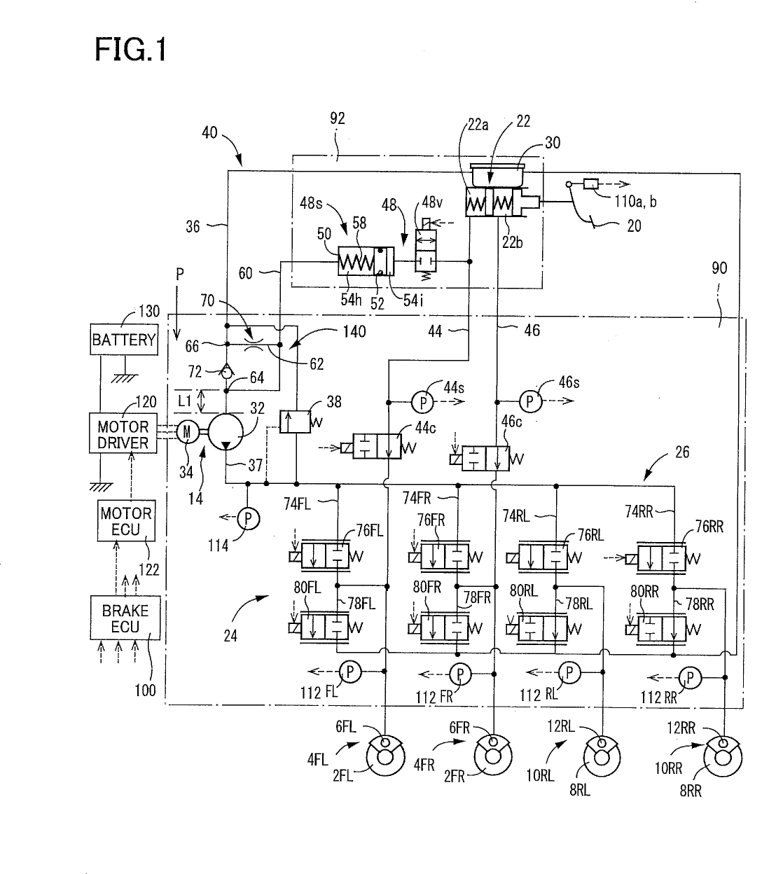

As illustrated in FIG. 1, the hydraulic braking system includes brake cylinders 6FL, 6FR, 12RL, 12RR, a pump device 14, a master cylinder 22, an electromagnetic valve device 24, and a common passage 26. The brake cylinders 6FL, 6FR are included in hydraulic brakes 4FL, 4FR respectively provided for front left and right wheels 2FL, 2FR. The brake cylinders 12RL, 12RR are included in hydraulic brakes 10RL, 10RR respectively provided for rear left and right wheels 8RL, 8RR. The pump device 14 serves as a power hydraulic pressure source capable of supplying a hydraulic pressure to each of the brake cylinders 6FL, 6FR, 12RL, 12RR. The master cylinder 22 serves as a manual hydraulic pressure source capable of supplying a hydraulic pressure to each of the brake cylinders 6FL, 6FR. The master cylinder 22 generates the hydraulic pressure in response to depression of a brake pedal 20 as a brake operating member. The electromagnetic valve device 24 includes a plurality of electromagnetic valves capable of controlling hydraulic pressures in the respective brake cylinders 6FL, 6FR, 12RL, 12RR. The common passage 26 is connected to the brake cylinders 6FL, 6FR, 12RL, 12RR, and the pump device 14 is connected to the common passage 26.

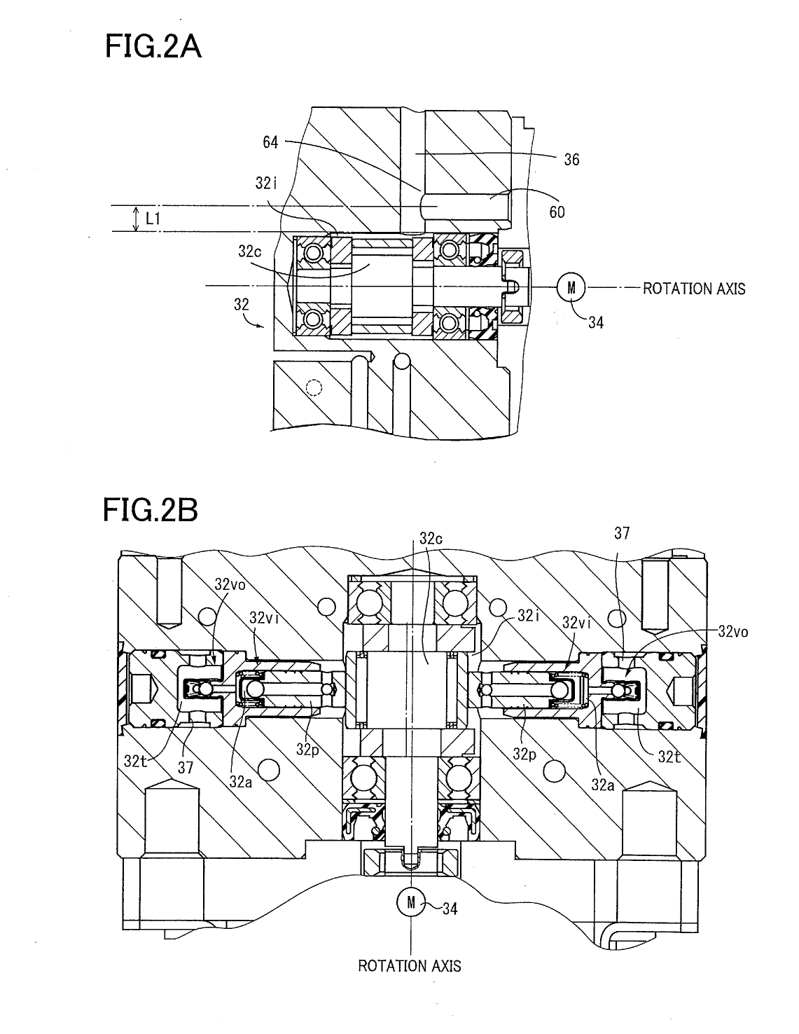

The pump device 14 includes: a pump 32 configured to suck and discharge working fluid; and a pump motor 34 configured to drive the pump 32. A suction portion of the pump 32 is connected to a reservoir 30 by a suction passage 36. A discharge portion of the pump 32 is connected to the common passage 26 by a discharge passage 37. A relief valve 38 is provided between a discharge side and a suction side of the pump 32 to prevent an excessively high hydraulic pressure of the working fluid discharged from the pump 32. In the present embodiment, the pump 32 is a plunger pump which as illustrated in FIGS. 2A and 2B includes: an eccentric cam 32c coupled to an output shaft of the pump motor 34; and a plurality of pistons 32p which are reciprocated by rotation of the eccentric cam 32c. The reciprocation of each of the pistons 32p causes the working fluid in a suction chamber 32i connected to the suction passage 36 to be sucked into a corresponding one of volume change chambers 32a via a corresponding one of suction valves 32vi. The working fluid is then compressed or pressurized and output to the discharge passage 37 via a corresponding one of discharge valves 32vo and a corresponding one of output chambers 32t. In the present embodiment, the suction chamber 32i corresponds to the suction portion, and each of the output chambers 32t corresponding to the discharge portion. A suction mechanism 40 is constituted by the suction chamber 32i of the pump 32, the suction passage 36, the reservoir 30, and other components.

The master cylinder 22 is a tandem cylinder including two pressurizing pistons. The brake pedal 20 is coupled to a rear one of the two pressurizing pistons. Pressure chambers 22a, 22b are defined in front of the respective pressurizing pistons. Depression of the brake pedal 20 moves the pressurizing pistons forward, so that hydraulic pressures related to foot power are generated in the respective pressure chambers 22a, 22b. The brake cylinders 6FL, 6FR are connected to the respective pressure chambers 22a, 22b by respective master passages 44, 46. Master cutoff valves 44c, 46c, each of which is a normally open electromagnetic valve, are provided on the respective master passages 44, 46. A master-cylinder-pressure sensor 44s is provided upstream of the master cutoff valve 44c to detect a hydraulic pressure in the pressure chamber 22a. A master-cylinder-pressure sensor 46s is provided upstream of the master cutoff valve 46c to detect a hydraulic pressure in the pressure chamber 22b. It is noted that a stroke simulator device 48 is provided on a master passage 44 at a position located upstream of the master cutoff valve 44c.

The stroke simulator device 48 includes a stroke simulator 48s and a simulator control valve 48v as a normally closed electromagnetic valve. The stroke simulator 48s includes a body 50 and a piston 52 fluid-tightly and slidably fitted in the body 50. The interior of the body 50 is partitioned by the piston 52 into two fluid chambers, namely, an input chamber 54i and a rearward pressure chamber 54h. The input chamber 54i is connected to a pressure chamber 22a, and a spring 58 is provided in the rearward pressure chamber 54h. The rearward pressure chamber 54h is connected to the suction passage 36 of the suction mechanism 40 by a first passage 60 and a second passage 62 provided in parallel. The first passage 60 is one example of a first simulator passage, and the second passage 62 is one example of a second simulator passage. For example, the second passage 62 may be branched off from the first passage 60 and connected to the suction passage 36. The first passage 60 is connected to a first connecting portion 64 of the suction passage 36. The second passage 62 is connected to a second connecting portion 66 of the suction passage 36. The second connecting portion 66 is farther from the pump 32 than the first connecting portion 64. A restrictor 70 is provided on the second passage 62. A check valve 72 is provided on the suction passage 36 at a position between the first connecting portion 64 and the second connecting portion 66. This check valve 72 allows a flow of the working fluid in a direction indicated by arrow P (hereinafter may be referred to as “direction P”), i.e., a direction directed from the second connecting portion 66 toward the pump 32 but prevents a flow of the working fluid in a direction reverse to the direction P. The restrictor 70 has such a shape that is capable of reducing a flow of the working fluid in the second passage 62. For example, the restrictor 70 may be in the form of an orifice.

The electromagnetic valve device 24 includes pressure holding valves 76FL, 76FR, 76RL, 76RR, pressure reduction valves 80FL, 80FR, and pressure reduction valves 80RL, 80RR. The brake cylinders 6FL, 6FR, 12RL, 12RR and the common passage 26 are connected by individual passages 74FL, 74FR, 74RL, 74RR, respectively. The brake cylinders 6FL, 6FR, 12RL, 12RR and the reservoir 30 are connected by the pressure reduction passages 78FL, 78FR, 78RL, 78RR, respectively. The pressure holding valves 76FL, 76FR, 76RL, 76RR are normally closed electromagnetic valves provided on the respective individual passages 74FL, 74FR, 74RL, 74RR. The pressure reduction valves 80FL, 80FR are normally closed electromagnetic valves provided on the respective pressure reduction passages 78FL, 78FR. The pressure reduction valves 80RL, 80RR are normally open electromagnetic valves provided on the respective pressure reduction passages 78RL, 78RR. In the following description, each of components such as the brake cylinders, the pressure holding valves, and the pressure reduction valves will be referred without a corresponding one of suffixes (FL, FR, RL, RR) indicative of the respective front left, front right, rear left, and rear right wheels where the components are collectively referred or where these components need not be distinguished by their respective wheel positions, for example. Each of the pressure holding valves 76 and the pressure reduction valves 80 is a linear control valve capable of continuously controlling a high-low pressure differential in response to control of an amount of current supplied to a solenoid. Hydraulic pressures in the respective brake cylinders 6, 12 may be controlled by the pressure holding valves 76 and the pressure reduction valves 80 so as to be substantially equal to each other and may be controlled individually such that a slip state of each of the wheels 2, 8 is appropriate with respect to a coefficient of friction of a road surface, for example.

In the present embodiment, devices including the electromagnetic valve device 24 and the pump device 14 are unitized into a first unit 90, and devices including the master cylinder 22 and the stroke simulator device 48 are unitized into a second unit 92 different from the first unit 90.

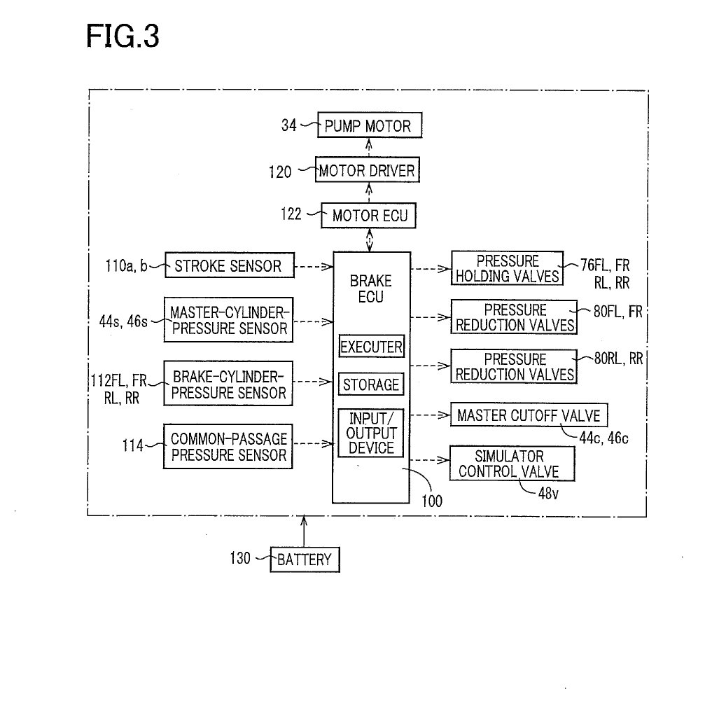

The present hydraulic braking system includes a brake ECU 100 illustrated in FIG. 3. The brake ECU 100 is principally constituted by a computer and includes an executer, a storage, and an input/output device. Devices and components connected to the input/output device include two stroke sensors 110a, 110b, the master-cylinder-pressure sensors 44s, 46s, brake-cylinder-pressure sensors 112FL, 112FR, 112RL, 112RR, a common-passage pressure sensor 114, the pressure holding valves 76, the pressure reduction valves 80, the master cutoff valves 44c, 46c, and the simulator control valve 48v. The stroke sensors 110a, 110b detect an operating stroke of the brake pedal 20. The brake-cylinder-pressure sensors 112FL, 112FR, 112RL, 112RR, are provided so as to correspond to the respective brake cylinders 6FL, 6FR, 12RL, 12RR and detect the hydraulic pressures in the respective brake cylinders 6FL, 6FR, 12RL, 12RR. The common-passage pressure sensor 114 detects a hydraulic pressure in the common passage 26. It is possible to consider that a value detected by the common-passage pressure sensor 114 is an average of hydraulic pressures in the respective four individual passages 74FL, 74FR, 74RL, 74RR and is a value of a hydraulic pressure output from the pump 32, for example. A motor ECU 122 is connected to the pump motor 34 via a motor driver 120. The motor ECU 122 is principally constituted by a computer and communicable with the brake ECU 100. It is noted that electric power is supplied from a battery 130 to the hydraulic braking system.

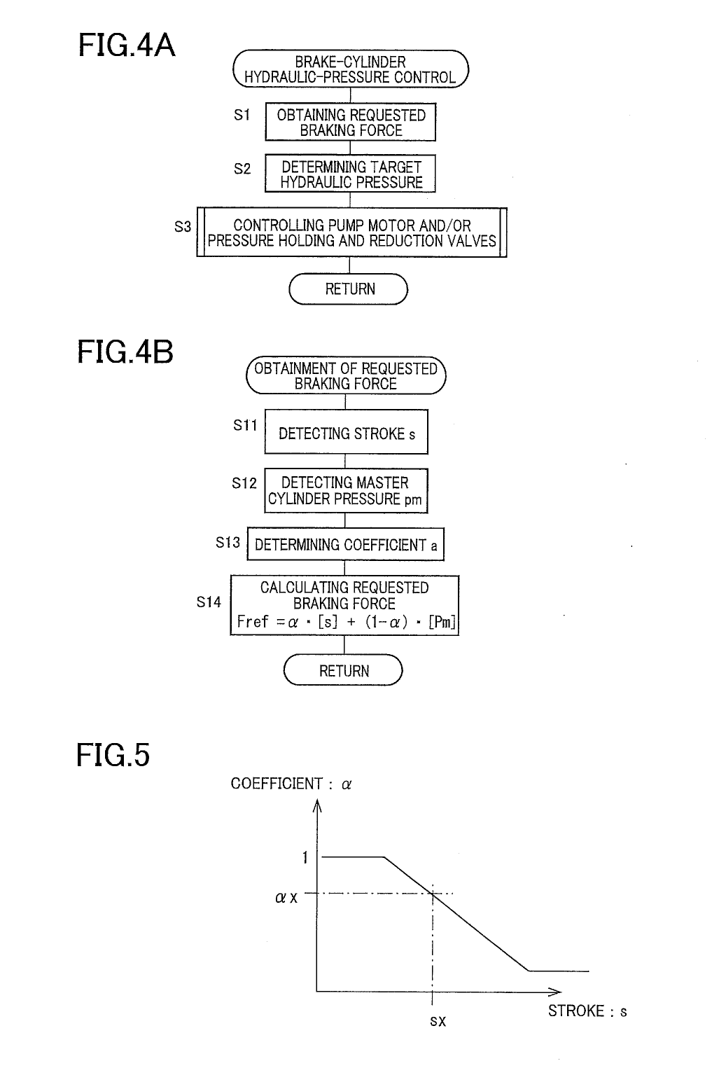

In this hydraulic braking system, when the brake pedal 20 is depressed, the master cutoff valves 44c, 46c are closed, and the simulator control valve 48v is opened, so that the pump device 14 is operated. The working fluid discharged from the pump 32 is supplied to the brake cylinders 6, 12 to actuate the hydraulic brakes 4, 10. A brake-cylinder hydraulic-pressure control program illustrated in FIG. 4A is executed to control the hydraulic pressures in the respective brake cylinders 6, 12. The present program is executed every time when a set length of time is elapsed in a state in which the brake pedal 20 is depressed. This flow begins with S1 at which a requested braking force is obtained. At S2, a target hydraulic pressure for each of the brake cylinders 6, 12 is determined to a value corresponding to the requested braking force. At S3, at least one of the pump motor 34 and the electromagnetic valve device 24 is controlled such that each of actual hydraulic pressures in the respective brake cylinders 6, 12, which are detected by the respective brake-cylinder-pressure sensors 112, is brought closer to the corresponding target hydraulic pressure. The same target hydraulic pressure is in most cases used for the four brake cylinders 6, 12, but different target hydraulic pressures may be used.

FIG. 4B is a flow chart indicating the obtainment of the requested braking force at S1. At S11, a stroke s of the brake pedal 20 is detected by the stroke sensors 110a, 110b. At S12, the master-cylinder-pressure sensors 44s, 46s detect a hydraulic pressure Pm in the pressure chambers 22a, 22b. The hydraulic pressure Pm is a physical quantity corresponding to foot power applied to the brake pedal 20. Each of the stroke s and the master cylinder pressure Pm may be determined as an average of values obtained by the corresponding two sensors, for example. At S13, a coefficient α is determined based on the stroke s and the table illustrated in FIG. 5. For example, in the case where the brake pedal 20 is operated by a stroke sx, the coefficient is determined to a coefficient αx. A requested braking force Fref is determined at S14 according to the following equation:

Fref=α·[s]+(1−α)·[Pm]

In this equation, the value [s] and the value [Pm] are values obtained by converting the stroke and the hydraulic pressure into forces.

The stroke simulator 48s is operated in response to depression of the brake pedal 20. The depression of the brake pedal 20 causes a hydraulic pressure to be produced in the pressure chamber 22a and supplied to the input chamber 54i. The hydraulic pressure in the input chamber 54i acts on the piston 52, so that the piston 52 is moved forward while compressing the spring 58. Consequently, the working fluid flows out of the rearward pressure chamber 54h. A reaction force related to, e.g., a resilient force of the spring 58 is applied to the brake pedal 20, so that a stroke related to the flow of the working fluid out of the rearward pressure chamber 54h (the forward movement of the piston 52) is allowed. When the depression of the brake pedal 20 is canceled, the working fluid flows from the reservoir 30 back to the rearward pressure chamber 54h via the suction passage 36 and the second passage 62 and via the suction passage 36 (the check valve 72 and the first connecting portion 64) and the first passage 60, so that the piston 52 is moved backward to a position at which the piston 52 is stopped by a stopper, not illustrated. Thus, a relationship between the stroke s and a reaction force Fp applied to the brake pedal 20 (which corresponds to an operating force) is determined by operation of the stroke simulator 48s, and an operation feeling is provided based on the operation of the stroke simulator 48s.

In the case where the temperature of the working fluid is lower than a set temperature, and thereby the working fluid becomes viscous, for example, a passage resistance increases, which makes it difficult for the working fluid to flow out of the rearward pressure chamber 54h. Thus, in the case where the temperature of the working fluid is lower than the set temperature, a ratio of the stroke s to an operating force Fp of the brake pedal 20 (s/Fp) is smaller than in the case where the temperature of the working fluid is higher than or equal to the set temperature. The set temperature may be determined to a temperature at which the viscosity of the working fluid increases to increase the passage resistance or may be determined to a temperature slightly higher than the temperature. For example, the set temperature may be determined between −20° C. and −30° C., preferably between −25° C. and −30° C. A driver may unfortunately feel discomfort because the operation feeling is different between the case where the temperature of the working fluid is lower than the set temperature (noted that this case may be hereinafter referred to as “at low temperatures”) and the temperature of the working fluid is higher than or equal to the set temperature (noted that this case may be hereinafter referred to as “at ordinary temperatures”). The requested braking force is determined based on the operating force and the stroke of the brake pedal 20 as described above, and it is in some cases difficult to obtain the requested braking force as a force having a magnitude desired by the driver, due to the difference in the operation feelings.

In contrast, the hydraulic braking system according to the present embodiment has the following constructions (a)-(d). That is, the rearward pressure chamber 54h formed in the stroke simulator 48s is connected to the suction passage 36 by the first passage 60 and the second passage 62 provided in parallel, and the restrictor 70 is provided on the second passage 62 (construction (a)). Since the restrictor 70 is provided on the second passage 62, the working fluid formed in the rearward pressure chamber 54h flows less easily via the second passage 62 and more easily via the first passage 60 at low temperatures at which the viscosity of the working fluid increases, than at ordinary temperatures. On the other hand, the viscosity of the working fluid is lower at ordinary temperatures than at low temperatures. Thus, the working fluid formed in the rearward pressure chamber 54h flows more easily via the second passage 62 at ordinary temperatures than at low temperatures even though the restrictor 70 is provided.

The first connecting portion 64 is provided on the suction passage 36 at a position nearer to the pump 32 than the second connecting portion 66 (construction (b)). The working fluid supplied to the first connecting portion 64 via the first passage 60 is more easily sucked by the pump 32 than the working fluid supplied to the second connecting portion 66 via the second passage 62. In the case where the working fluid supplied to the first connecting portion 64 is sucked by the pump 32, the working fluid easily flows from the rearward pressure chamber 54h via the first passage 60 because the passage resistance of the first passage 60 is low. This construction allows increase in stroke of the brake pedal 20. The working fluid supplied to the second connecting portion 66 via the second passage 62 is less easily sucked by the pump 32 and more easily transferred back to the reservoir 30 than the working fluid supplied to the first connecting portion 64. This is for the following reason. If the check valve 72 is not provided on the suction passage 36, the working fluid in the suction passage 36 flows in the direction P during suction of the pump 32, but the working fluid in the suction passage 36 flows toward the reservoir 30 in the case where a flow rate of the working fluid supplied to the first connecting portion 64 is greater than a flow rate of the working fluid sucked by the pump 32. The second connecting portion 66 is provided on the suction passage 36 at a position farther from the pump 32 than the first connecting portion 64. Thus, the working fluid supplied to the second connecting portion 66 is more easily transferred back to the reservoir 30 than the working fluid supplied to the first connecting portion 64. In reality, the check valve 72 is provided on the suction passage 36 between the first connecting portion 64 and the second connecting portion 66. Thus, even if the flow rate of the working fluid supplied to the first connecting portion 64 is greater than the flow rate of the working fluid sucked by the pump 32, the check valve 72 prevents flow of the working fluid toward the reservoir 30. Accordingly, a hydraulic pressure in an area between the check valve 72 and the suction portion of the pump 32 easily increases as described above. As a result, the working fluid supplied to the second connecting portion 66 does not easily flow toward the pump 32 via the check valve 72 and easily flows back to the reservoir 30.

As illustrated in FIG. 2, a first length L1 between the suction portion of the pump 32 and a center point of the first connecting portion 64 is shorter than a first set value L1th (construction (c)). The first set value L1th may be determined to such a length that allows the pump 32 to well suck the working fluid supplied to the first connecting portion 64. For example, in the case where the diameter of the first passage 60 is a diameter D, the first set value L1th is preferably determined to D or 2D but may be determined to any one of 5D, 10D, 20D, and so on. The first length L1 may also be determined to 0, that is, the first passage 60 may be directly connected to the suction chamber 32i of the pump 32 of the suction mechanism 40.

The check valve 72 is provided on the suction passage 36 between the first connecting portion 64 and the second connecting portion 66 (construction (d)). This construction provides the following effects. The check valve 72 prevents the flow of the working fluid in the direction reverse to the direction P, i.e., the direction from the pump 32 toward the reservoir 30, allowing the pump 32 to well suck the working fluid supplied to the first connecting portion 64. Thus, increase in stroke due to operation of the pump 32 is well allowed at low temperatures. Also, even in the case where the flow rate of the working fluid supplied to the first connecting portion 64 is greater than the flow rate of the working fluid sucked by the pump 32, the check valve 72 prevents the flow of the working fluid from the first connecting portion 64 toward the reservoir 30, allowing the pump 32 to well suck the working fluid supplied to the first connecting portion 64. Furthermore, the check valve 72 prevents increase in hydraulic pressure near the second connecting portion 66, which increase is caused because the working fluid not sucked by the pump 32 flows toward the second connecting portion 66. Thus, the flow of the working fluid via the second passage 62 is allowed at ordinary temperatures.

In view of the above, the constructions (a), (b) provide the effect in which the working fluid formed in the rearward pressure chamber 54h formed in the stroke simulator 48s is easily supplied to the first connecting portion 64 via the first passage 60 at low temperatures than at ordinary temperatures, allowing increase in stroke due to the suction of the pump 32. In contrast, the working fluid flows more easily from the rearward pressure chamber 54h via the second passage 62 at ordinary temperatures than at low temperatures, but the working fluid supplied to the second connecting portion 66 is sucked by the pump 32 less easily at ordinary temperatures than at low temperatures. Thus, the increase in stroke due to the suction of the pump 32 is reduced by a larger amount at ordinary temperatures than at low temperatures. This reduction reduces a difference between the operation feeling at low temperatures and the operation feeling at ordinary temperatures, making it possible to determine the requested braking force to a force desired by the driver regardless of whether it is at low temperatures or at ordinary temperatures. The construction (c) allows the pump 32 to more easily suck the working fluid supplied to the first connecting portion 64. The construction (d) allows the pump 32 to suck the working fluid supplied to the first connecting portion 64 more easily, allows the working fluid to flow out more easily via the second passage 62 at ordinary temperatures, and allows the working fluid supplied to the second connecting portion 66 to be transferred back to the reservoir 30 more easily. This results in further reduction in the difference between the operation feeling at low temperatures and the operation feeling at ordinary temperatures.

The check valve 72 does not prevent the flow of the working fluid in the direction P. Thus, even in the case where the flow rate of the working fluid supplied to the first connecting portion 64 is less than the flow rate of the working fluid sucked by the pump 32, the working fluid is supplied from the reservoir 30 to the suction portion of the pump 32. This supply of the working fluid prevents generation of a negative pressure in the suction portion of the pump 32. The working fluid having flowed out of the rearward pressure chamber 54h formed in the stroke simulator 48s is supplied to the suction portion of the pump 32, facilitating opening of the suction valves 32vi. In particular, the check valve 72 facilitates increase in a hydraulic pressure in the suction chamber 32i, further facilitating opening of the suction valves 32vi. This facilitation allows the working fluid to be quickly supplied to the brake cylinders 6, 12 upon operation of the pump 32, thereby reducing delay in actuation of the hydraulic brakes 4, 10. Thus, the working fluid is effectively sucked by the pump 32, resulting in improvement of performance of discharge of the pump 32 without increase in size of the pump 32. This improvement enables better supply of the working fluid to the brake cylinders 6, 12.

In the present embodiment, a flow restricting device is constituted by the restrictor 70. A pump suction reducer 140 is constituted by elements including the first passage 60, the second passage 62, the restrictor 70, and the check valve 72. The braking operation device is constituted by elements including the pump suction reducer 140, the stroke simulator device 48, and the suction portion of the pump 32. A brake hydraulic pressure controller is constituted by elements including the brake-cylinder-pressure sensors 112, the stroke sensors 110a, 110b, the master-cylinder-pressure sensors 44s, 46s, and portions of the brake ECU 100 which store and execute the brake-cylinder hydraulic-pressure control program.

It is noted that the rate of flow of the working fluid out of the rearward pressure chamber 54h is restricted due to the passage resistances of the first passage 60 and the second passage 62. Thus, in the case where the operating speed of the brake pedal 20 is greater than a set speed (noted that such an operation may be hereinafter referred to as “quick operation”), increase in stroke of the brake pedal 20 is not allowed in most cases, leading to a smaller ratio (s/Fp) of the stroke s to the operating force Fp of the brake operating member. As a result, the operation feeling is usually different between the case where the quick operation is performed and the case where the operating speed of the brake pedal 20 is less than the set speed (noted that such an operation may be hereinafter referred to as “normal operation”). In the present hydraulic braking system, in contrast, the restrictor 70 is provided on the second passage 62. With this construction, the working fluid flows more easily out of the rearward pressure chamber 54h through the first passage 60 in the quick operation than in the normal operation. Also, the flow rate is less in the normal operation than in the quick operation. Thus, even in the construction in which the restrictor 70 is provided, the working fluid flows more easily out of the rearward pressure chamber 54h through the second passage 62 in the normal operation than in the quick operation. As a result, increase in stroke of the brake pedal 20 due to the suction of the pump 32 is reduced by a larger amount in the normal operation than in the quick operation, resulting in reduced difference between the operation feeling in the quick operation and the operation feeling in the normal operation. Also, the requested braking force can be determined to a value desired by the driver regardless of whether the quick operation or the normal operation is being performed. It is noted that the set speed may be set to a value at which the driver feels discomfort because the ratio (s/Fp) is reduced by the restriction of the flow rate of the working fluid out of the rearward pressure chamber 54h. Alternatively, the set speed may be set to a value slightly smaller than the value at which the driver feels discomfort. The set speed is determined by the configuration of the stroke simulator 48s and the shape of the first passage 60, for example. In general, it is known that in the case where the increased speed of the stroke of the brake pedal 20 is close to 100 mm/sec, the increase in stroke is restricted, so that the driver feels discomfort. Thus, in the case where the set speed is represented as an increased speed of stroke, the set speed may be determined between 85 mm/sec and 115 mm/sec, for example. In the case where the set speed is represented as an increased speed of operating force, the set speed may be determined to a value obtained by converting the above-described value into the increased speed of the operating force.

### Second Embodiment

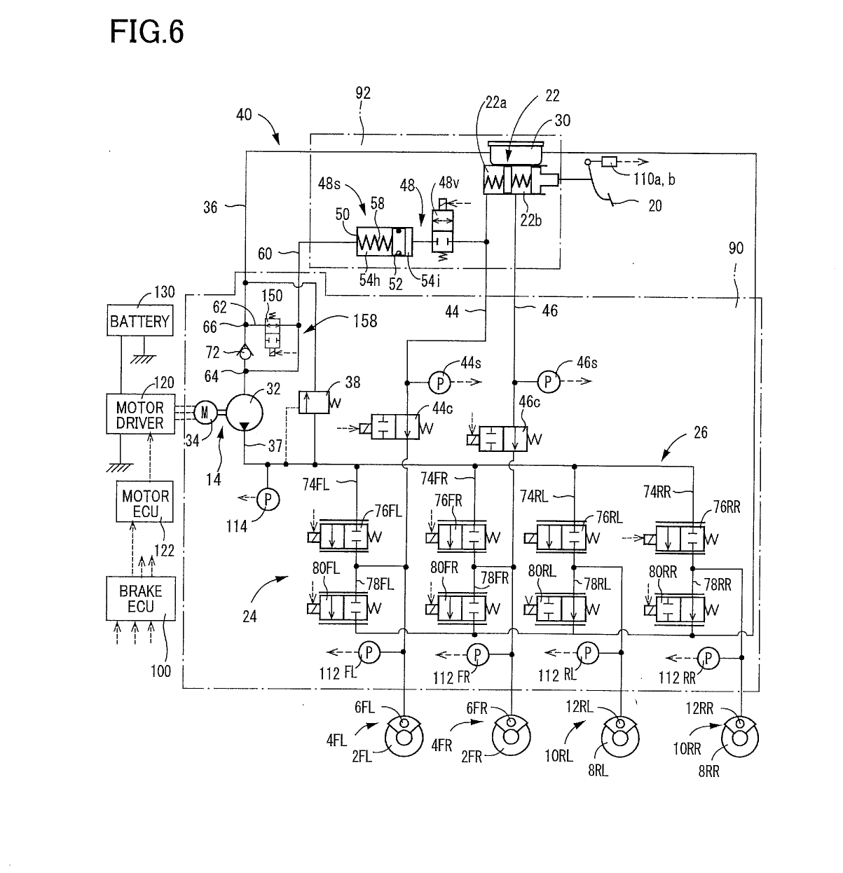

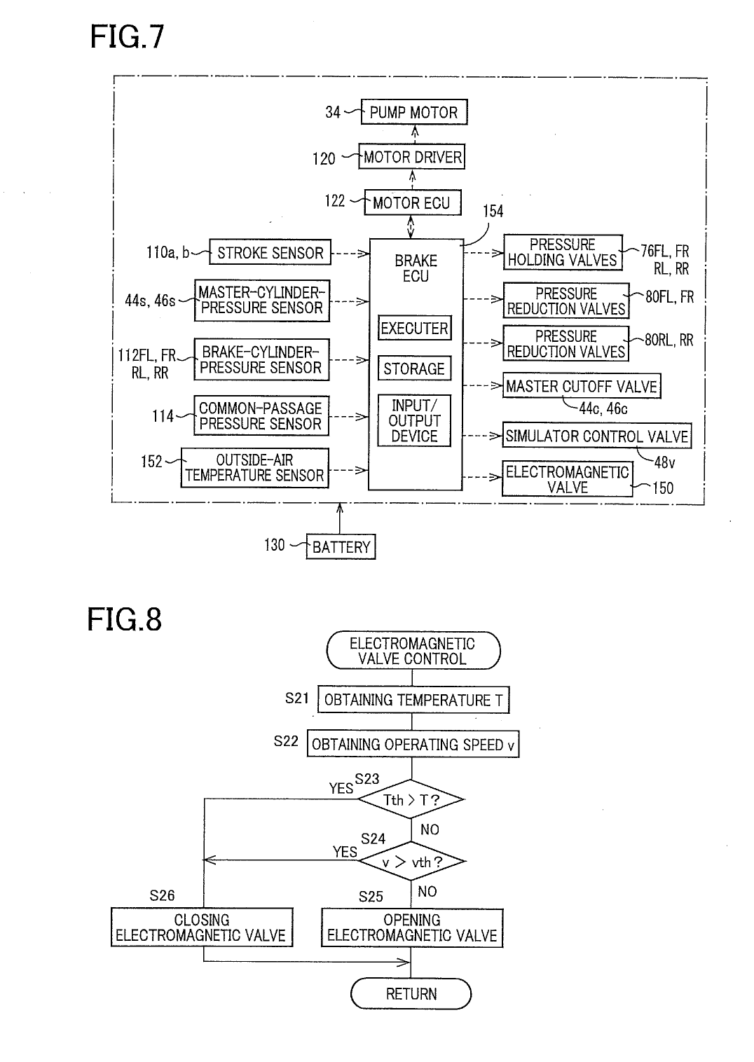

In the first embodiment, the restrictor 70 as the flow restricting device is provided on the second passage 62. In a second embodiment, as illustrated in FIG. 6, an electromagnetic valve 150 as the flow restricting device is provided on the second passage 62 instead of the restrictor 70. Also, an outside-air temperature sensor 152 is provided for detecting a temperature of outside air. As illustrated in FIG. 7, the electromagnetic valve 150 and the outside-air temperature sensor 152 are connected to an input/output device of a brake ECU 154. In the present embodiment, it is determined whether the temperature of the working fluid is lower than the set temperature, based on the temperature of the outside air which is detected by the outside-air temperature sensor 152. For example, the temperature of the working fluid may be estimated to be substantially equal to the temperature of the outside air and may be estimated based on the temperature of the outside air and a state of operation of an engine. For example, the state of operation of the engine may be represented as a length of time of operation of the engine. It is noted that, in the event of malfunction in an electrical system, the simulator control valve 48v is closed, and accordingly the electromagnetic valve 150 may be any of a normally open valve and a normally closed valve.

The electromagnetic valve 150 is controlled by execution of an electromagnetic-valve control program illustrated in FIG. 8. This flow begins with S21 at which the temperature of the outside air is detected by the outside-air temperature sensor 152, and the temperature T of the working fluid is obtained. At S22, an operating speed v is obtained. In the present embodiment, the operating speed v is determined as a speed of increase in the master cylinder pressure which corresponds to the operating force. An average of values detected by the master-cylinder-pressure sensors 44s, 46s is employed as the master cylinder pressure Pm, and a speed v of increase in the master cylinder pressure Pm (=dPm/dt) is obtained as an operating speed v. At S23, it is determined whether the temperature T of the working fluid is lower than a set temperature Tth. At S24, it is determined whether the operating speed v is higher than a set speed vth. The set temperature Tth may be determined to a temperature at which the viscosity of the working fluid is increased to increase the passage resistance or may be determined to a temperature slightly higher than the temperature. The set speed vth may be determined to a speed at which it is difficult for the working fluid to flow out of the rearward pressure chamber 54h at a flow rate related to the operating speed and may be determined to a speed slightly lower than the speed. When a positive decision (YES) is made at any of S23 and S24, the electromagnetic valve 150 is closed at S26. When a negative decision (NO) is made at both of S23 and S24, the electromagnetic valve 150 is opened at S25.

Thus, in the present embodiment, the electromagnetic valve 150 is closed in at least one of the case of lower temperatures and the case where the quick operation is performed. As a result, the working fluid formed in the rearward pressure chamber 54h is supplied to the first connecting portion 64 via the first passage 60. Accordingly, increase in stroke of the brake pedal 20 due to the suction of the pump 32 is allowed. In the case where the normal operation is performed at ordinary temperatures, the electromagnetic valve 150 is opened. The working fluid formed in the rearward pressure chamber 54h easily flows via the second passage 62, resulting in reduction in the increase in stroke of the brake pedal 20 due to the suction of the pump 32. As a result, it is possible to reduce a difference between the operation feeling at ordinary temperatures and the operation feeling at low temperatures and between the operation feeling in the normal operation and the operation feeling in the quick operation.

In the present embodiment, a pump suction reducer 158 is constituted by elements including the first passage 60, the second passage 62, the electromagnetic valve 150, the check valve 72, and portions of the brake ECU 154 which store and execute the electromagnetic-valve control program illustrated in FIG. 8. The electromagnetic valve 150 functions as a restrictor even when the electromagnetic valve 150 is open. Thus, the electromagnetic valve 150 being open functions as the flow restricting device even when an opening and closing control is not executed.

### Third Embodiment

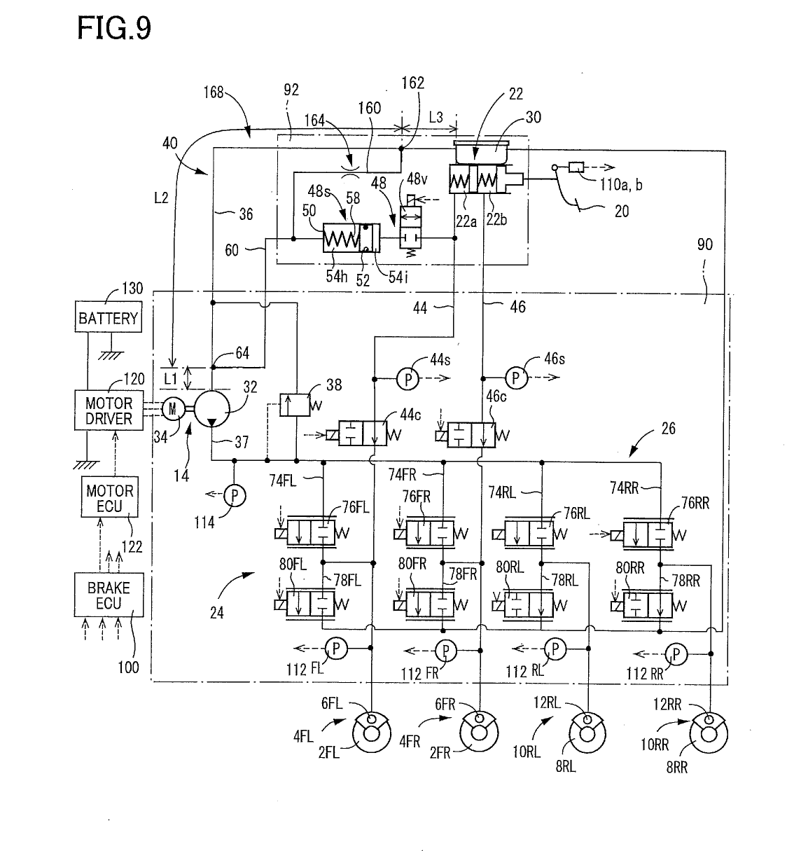

In the hydraulic braking system, it is not essential to provide the check valve 72 on the suction passage 36. FIG. 9 illustrates a construction without the check valve 72 by way of example. In the construction illustrated in FIG. 9, a second passage 160 as another example of the second simulator passage is connected to a second connecting portion 162 of the suction passage 36 of the suction mechanism 40 at a position near the reservoir 30. As in the first embodiment, a restrictor 164 as another example of the flow restricting device is provided on the second passage 160. In the present embodiment, a second length L2 of a portion of the suction passage 36 between the first connecting portion 64 and the second connecting portion 162 is longer than a second set value L2th. The second set value L2th may be determined to such a length in which the working fluid supplied to the first connecting portion 64 but not sucked by the pump 32 is not easily supplied to an area near the second connecting portion 162. That is, the second set value L2th is determined to such a length that a passage resistance with the second length L2 is capable of preventing the working fluid to flow from the first connecting portion 64 to the second connecting portion 162. For example, in the case where the diameter of the suction passage 36 is a diameter D′, the second set value L2th may be determined to any one of 2D′, 5D′, 10D′, 20D′, 50D′, and so on, for example. The diameter D′ of the suction passage 36 may be determined to a value obtained by statistically processing the diameters of the portion of the suction passage 36 between the first connecting portion 64 and the second connecting portion 162. For example, the diameter D′ may be determined to any of an average value, a minimum value, and so on. Also, a third length L3 between the center of the second connecting portion 162 and a connecting portion of the reservoir 30 is less than a third set value L3th. The third set value L3th may be determined to such a length that the working fluid supplied to the second connecting portion 162 can be reliably transferred back to the reservoir 30. For example, in the case where the diameter of the suction passage 36 is a diameter d, the third set value L3th may be determined to any one of d, 2d, 5d, 10d, 20d, 30d, and so on. The third length L3 may also be determined to zero. That is, the second passage 160 may be directly connected to the reservoir 30 of the suction mechanism 40. The diameter d of the suction passage 36 may be determined to a value obtained by statistically processing the diameters of a portion of the suction passage 36 between the second connecting portion 162 and the reservoir 30. For example, the diameter d may be determined to any of an average value, a minimum value, and so on.

In the present embodiment, the first length L1, the second length L2, and the third length L3 may be set so as to satisfy the following relationships (i) and (ii). The relationship (i) is that the second length L2 is long enough with respect to the first length L1. With this construction, the working fluid supplied to the first connecting portion 64 is well sucked by the pump 32, and it is difficult for a hydraulic pressure in the first connecting portion 64 to reach the second connecting portion 162. For example, a value L2/L1 may be greater than two and may be preferably determined to a value greater than or equal to 5, greater than or equal to 10, greater than or equal to 15, greater than or equal to 20, greater than or equal to 50, or greater than or equal to 100. The relationship (ii) is that the second length L2 is long enough with respect to the third length L3. With this construction, the working fluid supplied to the second connecting portion 162 is well transferred back to the reservoir 30 and not easily supplied to the pump 32. For example, a value L2/L3 may be greater than two and may be preferably determined to a value greater than or equal to 5, greater than or equal to 10, greater than or equal to 15, greater than or equal to 20, greater than or equal to 50, or greater than or equal to 100.

In view of the above, the working fluid flows to the second connecting portion 162 via the second passage 160 more easily and flows back to the reservoir 30 more easily at ordinary temperatures than at low temperatures. This construction can reduce a difference between the operation feeling at low temperatures and the operation feeling at ordinary temperatures, whereby the requested braking force can be determined to a value desired by the driver.

In the present embodiment, a pump suction reducer 168 is constituted by elements including the first passage 60, the second passage 160, the restrictor 164, the first connecting portion 64, and the second connecting portion 162.

### Fourth Embodiment

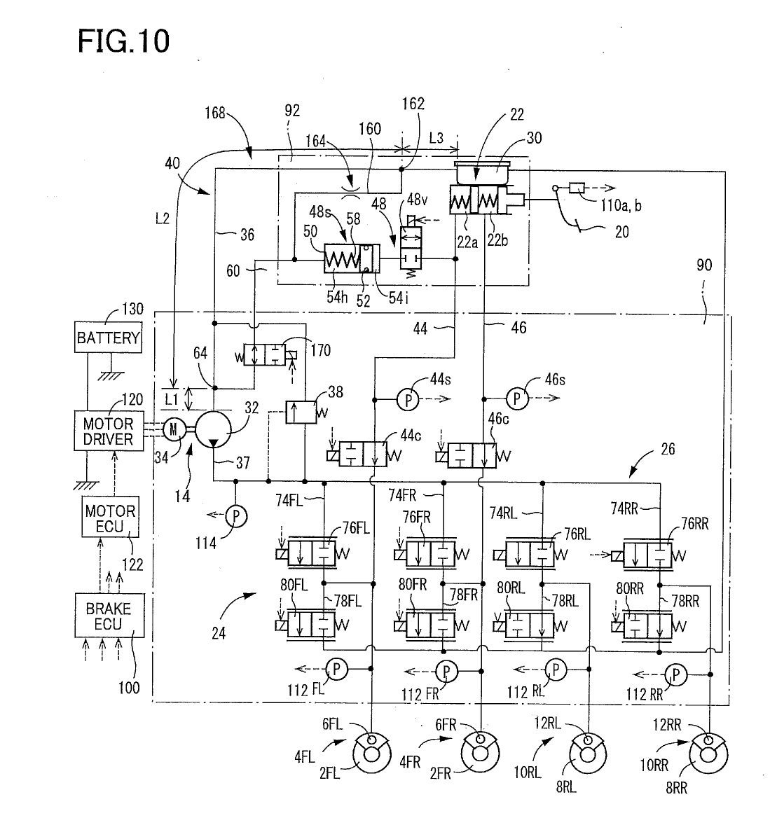

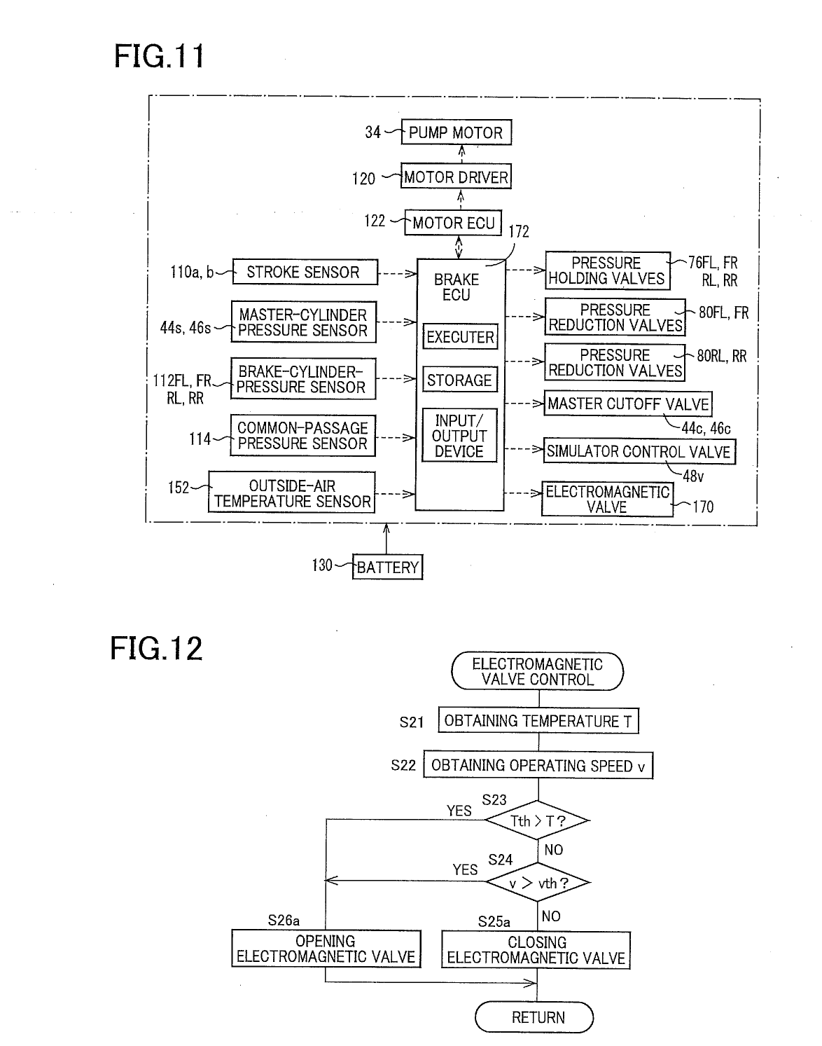

It is noted that, as illustrated in FIG. 10, an electromagnetic valve 170 may be provided on the first passage 60. As illustrated in FIG. 11, the electromagnetic valve 170 is connected to an input/output device of a brake ECU 172. A storage of the brake ECU 172 stores an electromagnetic-valve control program illustrated in FIG. 12. The electromagnetic valve 170 is controlled by execution of this electromagnetic-valve control program. It is noted that the same reference numerals as used in the first embodiment are used to designate the corresponding elements of the second embodiment, and an explanation of which is dispensed with. The same step numbers as used in the flow chart in FIG. 8 will be used to designate the corresponding steps in the flow chart in FIG. 12, and descriptions of these steps will be omitted. This flow begins with S21 at which the temperature T of the working fluid is obtained. At S22, the operating speed v is obtained. At S23, it is determined whether the temperature T of the working fluid is lower than the set temperature Tth. At S24, it is determined whether the operating speed v is higher than the set speed vth. When the positive decision (YES) is made at any of S23 and S24, the electromagnetic valve 170 is opened at S26a. When a negative decision (NO) is made at both of S23 and S24, the electromagnetic valve 170 is closed at S25a. The electromagnetic valve 170 is open at low temperatures and in the quick operation and is closed at ordinary temperatures and in the normal operation. This construction allows the working fluid to reliably flow to the reservoir 30 via the second passage 160 at ordinary temperatures and in the normal operation. It is noted that the electromagnetic valve 170 may be provided on the first passage 60 in the hydraulic braking system according to the first embodiment.

It is noted that a circuit of the hydraulic braking system is not limited. The devices located downstream of the common passage 26, the master cylinder 22, the stroke simulator device 48, the units 90, 92 and so on are not limited in construction to those in the above-described embodiments. For example, the unit 90 may be provided with the simulator device 48. It is to be understood that the disclosure is not limited to the details of the illustrated embodiments, but may be embodied with various changes and modifications, which may occur to those skilled in the art, without departing from the spirit and scope of the disclosure.

### Claimable Inventions

(1) A hydraulic braking system, comprising:

a stroke simulator configured to be operated in response to an operation of a brake operating member;

a pump configured to suck and discharge working fluid;

a hydraulic brake comprising a brake cylinder connected to the pump, the hydraulic brake being configured to be operated by a hydraulic pressure in the brake cylinder;

a suction mechanism comprising a reservoir, a suction portion of the pump, and a suction passage connecting between the reservoir and the suction portion of the pump;

a first simulator passage connecting between the stroke simulator and the suction mechanism at a first connecting portion of the suction mechanism;

a second simulator passage connecting between the stroke simulator and the suction mechanism in parallel with the first simulator passage at a second connecting portion of the suction mechanism, the second connecting portion being farther from the suction portion of the pump than the first connecting portion; and

a flow restricting device provided on the second simulator passage.

The first connecting portion and the second connecting portion are provided in the suction mechanism but may be provided in the suction portion of the pump and the reservoir, respectively.

(2) The hydraulic braking system according to the above form (1),

wherein the stroke simulator comprises:
a simulator body;
a piston fluid-tightly and slidably fitted in the simulator body and movable forward in response to the operation of the brake operating member;
a rearward pressure chamber defined in front of the piston; and
a spring provided in the rearward pressure chamber, and

wherein the rearward pressure chamber is connected to the suction mechanism via the first simulator passage and the second simulator passage.

A flow of the working fluid out of the rearward pressure chamber allows compression of the spring, allowing a stroke of the brake operating member.

(3) The hydraulic-pressure producing device according to the above form (1) or (2), wherein the flow restricting device has a restricting function for restricting a flow of the working fluid in the second simulator passage.

Examples of devices and components having the restricting function include a restrictor (including an orifice) and a valve. The flow restricting device may include at least one or two restrictors and/or valves, for example.

(4) The hydraulic braking system according to any one of the above forms (1) through (3),

wherein the flow restricting device comprises a first electromagnetic valve provided on the second simulator passage, and

wherein the hydraulic braking system comprises a first electromagnetic valve controller configured to close the first electromagnetic valve in at least one of a situation in which a temperature of the working fluid is less than a set temperature and a situation in which a speed of operation of the brake operating member is greater than a set speed.

By closing the first electromagnetic valve, the flow of the working fluid in the second simulator passage is restricted or inhibited in both directions.

(5) The hydraulic braking system according to any one of the above forms (1) through (4), further comprising a check valve provided between the first connecting portion and the second connecting portion of the suction mechanism,

wherein the check valve is configured to allow a flow of the working fluid from the second connecting portion to the first connecting portion and prevent a flow of the working fluid from the first connecting portion to the second connecting portion.

(6) The hydraulic braking system according to any one of the above forms (1) through (5), wherein a first length L1 that is a length of a portion of the suction mechanism between the suction portion of the pump and the first connecting portion is less than a first set value L1th (L1<L1th).

(7) The hydraulic braking system according to any one of the above forms (1) through (6), wherein a second length L2 that is a length of a portion of the suction mechanism between the first connecting portion and the second connecting portion is greater than a second set value L2th (L2>L2th).

(8) The hydraulic braking system according to the above form (7), wherein a ratio (L2/L1) of the second length (L2) to the first length (L1) is a value greater than two.

(9) The hydraulic braking system according to any one of the above forms (1) through (8), wherein a third length L3 that is a length of a portion of the suction mechanism between the second connecting portion and a connecting portion of the reservoir is less than a third set value L3th (L3<L3th).

(10) The hydraulic braking system according to any one of the above forms (1) through (9), further comprising a unit comprising the pump,

wherein the first connecting portion is provided inside the unit of the suction mechanism, and

wherein the second connecting portion is provided outside the unit of the suction mechanism.

The check valve is unnecessary in some cases in the hydraulic braking system according to this form.

(11) The hydraulic braking system according to any one of the above forms (1) through (10), further comprising:

a second electromagnetic valve provided on the first simulator passage; and

a second electromagnetic valve controller configured to close the second electromagnetic valve in at least one of a situation in which a temperature of the working fluid is greater than or equal to a set temperature and a situation in which a speed of operation of the brake operating member is less than or equal to a set speed.

When the speed of operation of the brake operating member is normal at ordinary temperatures, the electromagnetic valve is closed to shut off the first simulator passage. In this state, the working fluid in the stroke simulator is supplied to the suction mechanism via the second simulator passage.

(12) A hydraulic braking system, comprising:

a stroke simulator configured to be operated in response to an operation of a brake operating member;

a pump configured to suck and discharge working fluid;

a hydraulic brake comprising a brake cylinder connected to the pump, the hydraulic brake being configured to be operated by a hydraulic pressure in the brake cylinder;

a suction mechanism comprising a reservoir, a suction portion of the pump, and a suction passage connecting between the reservoir and the suction portion of the pump; and

a pump suction reducer provided between the stroke simulator and the suction mechanism and configured to make it more difficult for the working fluid in the stroke simulator to be sucked by the pump in a situation in which a temperature of the working fluid is greater than or equal to a set temperature than in a situation in which the temperature of the working fluid is less than the set temperature.

The hydraulic braking system according to this form may incorporate the technical features of any one of the above forms (1) through (11).

(13) A hydraulic braking system, comprising:

a stroke simulator configured to be operated in response to an operation of a brake operating member;

a pump configured to suck and discharge working fluid;

a hydraulic brake comprising a brake cylinder connected to the pump, the hydraulic brake being configured to be operated by a hydraulic pressure in the brake cylinder;

a suction mechanism comprising a reservoir, a suction portion of the pump, and a suction passage connecting between the reservoir and the suction portion of the pump; and

a pump suction reducer provided between the stroke simulator and the suction mechanism and configured to make it more difficult for the working fluid in the stroke simulator to be sucked by the pump in a situation in which a speed of operation of the brake operating member is less than or equal to a set speed than in a situation in which the speed of operation of the brake operating member is greater than the set speed.

The speed of operation of the brake operating member may be represented as an increased speed of stroke and an increased speed of operating force, for example, but is preferably represented as the increased speed of the operating force. The hydraulic braking system according to this form may incorporate the technical features of any one of the above forms (1) through (12).

(14) The hydraulic braking system according to any one of the above forms (1) through (13), further comprising:

a pump device comprising the pump and a pump motor configured to drive the pump; and

a brake hydraulic pressure controller configured to control the hydraulic pressure in the brake cylinder by at least controlling the pump motor,

wherein the brake hydraulic pressure controller comprises:
a requested braking force obtainer configured to obtain a requested braking force desired by a driver, based on an operating stroke and an operating force of the brake operating member; and
a target hydraulic pressure determiner configured to determine a target hydraulic pressure based on the requested braking force obtained by the requested braking force obtainer, the target hydraulic pressure being a target value of the hydraulic pressure in the brake cylinder, and

wherein the brake hydraulic pressure controller is configured to at least control the pump motor such that the hydraulic pressure in the brake cylinder is brought closer to the target hydraulic pressure.

(15) A braking operation device, comprising:

a stroke simulator configured to be operated in response to an operation of a brake operating member;

a first simulator passage configured to connect between a suction mechanism and the stroke simulator at a first connecting portion of the suction mechanism, the suction mechanism comprising a suction portion of a pump, a reservoir, and a suction passage connecting between the suction portion of the pump and the reservoir;

a second simulator passage configured to connect between the suction mechanism and the stroke simulator in parallel with the first simulator passage at a second connecting portion of the suction mechanism, the second connecting portion being farther from the pump than the first connecting portion; and

a flow restricting device provided on the second simulator passage.

The braking operation device according to this form may incorporate the technical features of any one of the above forms (1) through (14).

What is claimed is:

1. A hydraulic braking system, comprising:
a stroke simulator configured to be operated in response to an operation of a brake operating member;
a pump configured to suck and discharge working fluid;
a hydraulic brake comprising a brake cylinder connected to the pump, the hydraulic brake being configured to be operated by a hydraulic pressure in the brake cylinder;
a suction mechanism comprising a reservoir, a suction portion of the pump, and a suction passage connecting between the reservoir and the suction portion of the pump;
a first simulator passage connecting between the stroke simulator and the suction mechanism at a first connecting portion of the suction mechanism;
a second simulator passage connecting between the stroke simulator and the suction mechanism in parallel with the first simulator passage at a second connecting portion of the suction mechanism, the second connecting portion being farther from the suction portion of the pump than the first connecting portion; and
a flow restricting device provided on the second simulator passage.

2. The hydraulic braking system according to claim 1, wherein the flow restricting device comprises at least one restrictor configured to restrict a flow of the working fluid in the second simulator passage.

3. The hydraulic braking system according to claim 1, wherein the flow restricting device comprises at least one valve provided on the second simulator passage.

4. The hydraulic braking system according to claim 1, wherein a first length that is a length of a portion of the suction mechanism between the suction portion of the pump and the first connecting portion is less than a first set value.

5. The hydraulic braking system according to claim 1, further comprising a check valve provided between the first connecting portion and the second connecting portion of the suction mechanism,
wherein the check valve is configured to allow a flow of the working fluid from the second connecting portion to the first connecting portion and prevent a flow of the working fluid from the first connecting portion to the second connecting portion.

6. The hydraulic braking system according to claim 1,
wherein a first length is a length of a portion of the suction mechanism between the suction portion of the pump and the first connecting portion,
wherein a second length is a length of a portion of the suction mechanism between the first connecting portion and the second connecting portion,
wherein a ratio of the second length to the first length is a value greater than two.

7. The hydraulic braking system according to claim 1, further comprising a unit comprising the pump,
wherein the first connecting portion is provided inside the unit of the suction mechanism, and
wherein the second connecting portion is provided outside the unit of the suction mechanism.

8. A hydraulic braking system, comprising:
a stroke simulator configured to be operated in response to an operation of a brake operating member;
a pump configured to suck and discharge working fluid;
a hydraulic brake comprising a brake cylinder connected to the pump, the hydraulic brake being configured to be operated by a hydraulic pressure in the brake cylinder;
a suction mechanism comprising a reservoir, a suction portion of the pump, and a suction passage connecting between the reservoir and the suction portion of the pump; and
a pump suction reducer provided between the stroke simulator and the suction mechanism and configured to make it more difficult for the working fluid in the stroke simulator to be sucked by the pump in a situation in which a temperature of the working fluid is greater than or equal to a set temperature than in a situation in which the temperature of the working fluid is less than the set temperature.

9. A hydraulic braking system, comprising:
a stroke simulator configured to be operated in response to an operation of a brake operating member;
a pump configured to suck and discharge working fluid;
a hydraulic brake comprising a brake cylinder connected to the pump, the hydraulic brake being configured to be operated by a hydraulic pressure in the brake cylinder;
a suction mechanism comprising a reservoir, a suction portion of the pump, and a suction passage connecting between the reservoir and the suction portion of the pump; and
a pump suction reducer provided between the stroke simulator and the suction mechanism and configured to make it more difficult for the working fluid in the stroke simulator to be sucked by the pump in a situation in which a speed of operation of the brake operating member is less than or equal to a set speed than in a situation in which the speed of operation of the brake operating member is greater than the set speed.

10. A braking operation device, comprising:
a stroke simulator configured to be operated in response to an operation of a brake operating member;
a first simulator passage configured to connect between a suction mechanism and the stroke simulator at a first connecting portion of the suction mechanism, the suction mechanism comprising a suction portion of a pump, a reservoir, and a suction passage connecting between the suction portion of the pump and the reservoir;
a second simulator passage configured to connect between the suction mechanism and the stroke simulator in parallel with the first simulator passage at a second connecting portion of the suction mechanism, the second connecting portion being farther from the pump than the first connecting portion; and
a flow restricting device provided on the second simulator passage.
